(19) United States
(12) Patent Application Publication
(10) Pub. No.: US 2016/0357411 A1
(43) Pub. Date: Dec. 8, 2016

(54) MODIFYING A USER-INTERACTIVE DISPLAY WITH ONE OR MORE ROWS OF KEYS

(71) Applicant: MICROSOFT TECHNOLOGY LICENSING, LLC, Redmond, WA (US)

(72) Inventors: Rouella Joan MENDONCA, Redmond, WA (US); Andrew Stuart GLASS, Seattle, WA (US); Timothy S. PAEK, Sammamish, WA (US); Gyancarlo Garcia AVILA, Kenmore, WA (US)

(21) Appl. No.: 14/733,850

(22) Filed: Jun. 8, 2015

(51) Int. Cl. G06F 3/0484; G06F 3/0488; G06F 3/0482

(52) U.S. Cl. CPC G06F 3/04845; G06F 3/0482; G06F 3/0488

(57) ABSTRACT

Examples of the disclosure enable a user-interactive display presented on a touch-sensitive input panel to be modified. In some examples, a request to modify an arrangement of a plurality of keys presented on the touch-sensitive input panel is generated. The keys are arranged in a first quantity of rows and are associated with a first set of characters including a first plurality of characters and a second plurality of characters. A first key is associated with the first plurality of characters, and a second key is associated with the second plurality of characters. Based on the generated request, the keys are arranged in a second quantity of rows different from the first quantity of rows. Aspects of the disclosure enable a mobile device to be customized such that a user may provide input (e.g., via typing) in a user-friendly manner.

### BACKGROUND

At least some known mobile devices include a touchscreen that displays or presents content (e.g., images, alphanumeric characters). Mobile devices are increasingly used for a variety of purposes including word processing or electronic mail (“e-mail”). To prompt input (e.g., typing), at least some known mobile devices display a virtual keyboard on the touchscreen. Displaying a conventional arrangement of keys on a relatively small screen, however, may make it awkward, tedious, and/or time consuming for at least some users (e.g., users with larger fingers, users having less dexterity) to type on the mobile device.

### SUMMARY

Examples of the disclosure enable a user-interactive display presented on a touch-sensitive input panel to be modified. In some examples, a request to modify an arrangement of a plurality of keys presented on the touch-sensitive input panel is generated. The plurality of keys are arranged in a first quantity of rows and are associated with a first set of characters including a first plurality of characters and a second plurality of characters. A first key of the plurality of keys is associated with the first plurality of characters, and a second key of the plurality of keys is associated with the second plurality of characters. Based on the generated request, the plurality of keys are arranged in a second quantity of rows different from the first quantity of rows.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a functional block diagram of an example system that facilitates decoding text entered by way of a touch-sensitive input panel.

FIG. 2 is a flowchart of an example method of modifying a user-interactive display using a system, such as the system shown in FIG. 1.

FIG. 3 is a screenshot of an example user-interactive display presented on an example mobile device.

FIG. 4 is a screenshot of another example user-interactive display presented on a mobile device, such as the mobile device shown in FIG. 3.

FIG. 5 is a screenshot of an example user-interactive display presented on another mobile device.

FIG. 6 is a screenshot of another example user-interactive display presented on a mobile device, such as the mobile device shown in FIG. 5.

FIG. 7 is a screenshot of yet another example user-interactive display presented on a mobile device, such as the mobile device shown in FIG. 5.

FIG. 8 is a schematic diagram of an example computing device that may be used with a mobile device, such as the mobile device shown in FIG. 3 or the mobile device shown in FIG. 6.

FIG. 9 is a flowchart of an example method of modifying a user-interactive display using a computing device, such as the computing device shown in FIG. 8.

Corresponding reference characters indicate corresponding parts throughout the drawings.

### DETAILED DESCRIPTION

Examples of the disclosure enable a user-interactive display (e.g., a virtual keyboard) to be modified. In some examples, a request to modify an arrangement of a plurality of keys is generated. Based on the generated request, the plurality of keys are rearranged. The plurality of keys may be configurable between a first arrangement including a first quantity of rows and a second arrangement including a second quantity of rows different from the first quantity of rows.

Aspects of the disclosure enable a user-interactive display to be modified such that a user may provide input (e.g., via typing) in a user-friendly manner. The user-interactive display may be modified between a first arrangement including a first quantity of rows and a second arrangement including a second quantity of rows different from the first quantity of rows. In this way, the keys and/or the rows of keys may be sized to enable better fit on a touch-sensitive input panel and/or to accommodate more users (e.g., users with larger fingers, users having less dexterity). By incorporating user-interactive display customization in the manner described in this disclosure, some examples enable improved usability, improved user efficiency via user interface interaction, increased user interaction performance, and/or reduced error rate.

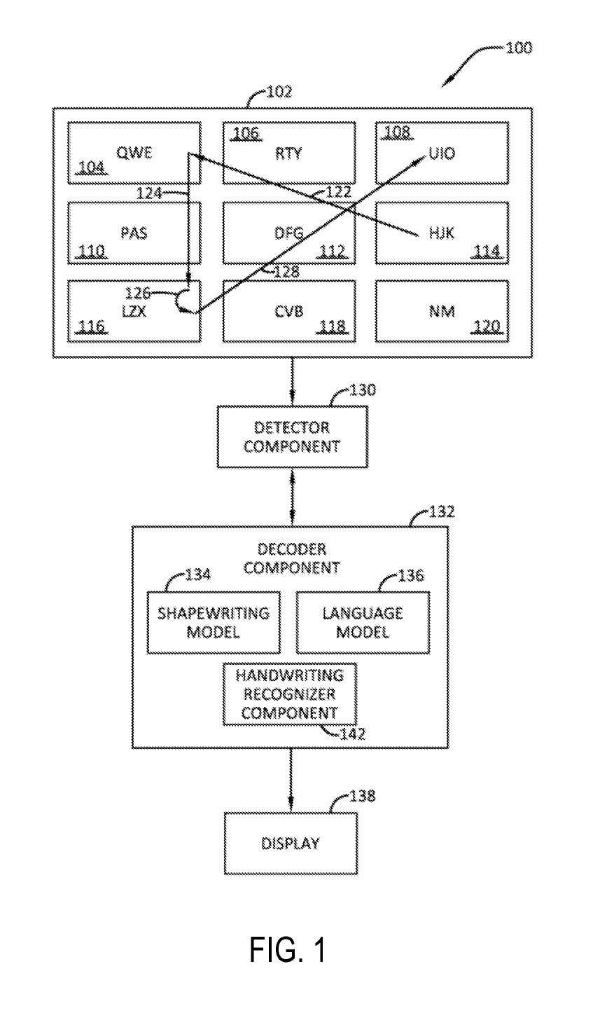

FIG. 1 illustrates an example system 100 that facilitates decoding text input. The system 100 includes a touch-sensitive input panel 102. The touch-sensitive input panel 102 may be displayed on a touch-sensitive display of a mobile computing device, such as a mobile telephone, a tablet computing device, an ultra-book, or the like. The touch-sensitive input panel 102 may be a capacitive touchpad positioned on a housing of a computing device, such as on a rearward portion of a mobile computing device. The touch-sensitive input panel 102 may be integral to or configured to be an accessory to a computing device. For instance, the touch-sensitive input panel 102 may be integral to a steering wheel of a car, may be coupled to a steering wheel of a car, may be positioned on an armrest of a chair, etc.

The touch-sensitive input panel 102 includes a plurality of keys 104-120. Each key 104-120 is a character key, in that each key is representative of a respective plurality of characters. For example, the key 104 is representative of the characters “Q.” “W,” and “E,” the key 106 is representative of the characters “R.” “T.” and “Y,” etc. The characters in the touch-sensitive input panel 102 are arranged in accordance with a QWERTY keyboard. Alternatively, characters may be arranged in alphabetical order or some other suitable arrangement. The touch-sensitive input panel 102 may also include additional keys, such as an “enter” key, a space bar key, numerical keys, and other keys found on conventional keyboards.

The touch-sensitive input panel 102 may be configured to receive input from a digit of a user by way of shapewriting (e.g., a continuous sequence of strokes over the touch-sensitive input panel 102). As used herein, the term “shapewriting” is a continuous interaction with a touch-sensitive input panel to select one or more keys 104-120, rather than the tapping of discrete keys 104-120. As used herein, a “stroke” is the continuous interaction with a touch-sensitive input panel between one key 104-120 and another key 104-120. In other words, rather than the user individually tapping keys 104-120, the user may employ a digit, a stylus, or other input device to connect keys 104-120 that are representative of respective letters in a desired word.

In an example, a user may desirably employ the touch-sensitive input panel 102 to enter the word “hello.” The user initially places her digit on the key 114, which represents the characters “H,” “J,” and “K.” The user then transitions her digit from the key 114 to the key 104, which represents the characters “Q,” “W,” and “E.” The transition from the key 114 to the key 104 is shown as being a first stroke 122. While the digit maintains contact with the touch-sensitive input panel 102, the user transition the digit from the key 104 to the key 116, which represents the characters “L,” “Z” and “X.” Accordingly, by transitioning from the key 104 to the key 116, the user has set forth a second stroke 124. Thus, the user has selected keys representative of the first three letters of the word “hello.”

At this point, the user may desire to indicate a subsequent selection of the letter “L” in the word “hello.” This may be undertaken in a variety of manners. In one example, the user sets forth a third stroke 126, which may be a circular stroke undertaken over the key 116. Accordingly, through a relatively small stroke, the user indicates that she desires to select another character represented by the key 116. In another example, the user pauses over the key 116 without setting forth another stroke. Again, such pause may be indicative of a desire to consecutively select the key 116. In at least some examples, a subsequent selection of the same key may be omitted, as possible spelling errors may be corrected. The user then sets forth a fourth stroke 128 by transitioning her digit from the key 116 to the key 108. Subsequent to the fourth stroke 128 being set forth by the user, the user removes her digit from the touch-sensitive input panel 102. While the sequence of strokes 122-128 are shown as being discrete strokes, it is to be understood that, in practice, a trace of the digit of the user over the touch-sensitive input panel 102 may appear as a continuous, curved shape with no readily ascertainable differentiation between strokes.

The system 100 includes a detector component 130 configured to detect strokes set forth by the user over the touch-sensitive input panel 102. For example, the detector component 130 may detect the sequence of strokes 122-128, wherein the user transitions her digit from the key 114 to the key 104, followed by transition of her digit to the key 116, followed by her transition of her digit to the key 108.

A decoder component 132 is in communication with the detector component 130 and is configured to decode the sequence of strokes 122-128 set forth by the user of the touch sensitive input panel 102, such that the decoder component 132 determines a sequence of characters (e.g., a word) desirably set forth by such user. Pursuant to an example, the decoder component 132 receives a signal from the detector component 130 that is indicative of the sequence of strokes 122-128 set forth by the user over the touch-sensitive input panel 102, and decodes such sequence of strokes 122-128 and output the word “hello.” As each of the keys 104-120 is representative of a respective plurality of characters, the decoder component 132 may disambiguate between potential words that may be constructed based upon the strokes set forth by the user (e.g., based upon characters in respective keys over which a trace of the digit has passed or to which the trace of the digit is proximate). The decoder component 132 may be configured to correct for possible spelling errors entered by the user, as well as errors in position of the digit of the user over the keys 104-120 in the touch-sensitive input panel 102. For example, a subsequent selection of the same key (e.g., the selection of the second “1” in “hello”) may have been omitted and/or a quantity of consecutive selections of one key may be ambiguous. In such an instance, the decoder component 132 may decode a selection of the keys 114, 104, 116, and 108 as “helo,” compare “helo” with a predefined dictionary, and output the word “hello.”

In connection with performing such decoding, the decoder component 134 may include one or more shapewriting models 134 that are trained using labeled words and corresponding traces over touch-sensitive input panels set forth by users. In at least some examples, each layout (e.g., arrangement of keys) has a corresponding shapewriting model 134. For example, a first shapewriting model 134 is used with a first layout, and a second shapewriting model 134 is used with a second layout.

With more particularity, during a data collection/model training phase, a user may be instructed to set forth a trace (e.g., continuous sequence of strokes) over a touch-sensitive input panel for a prescribed word. Position of such trace may be assigned to the word, and such operation may be repeated for multiple different users and multiple different words. Variances may be learned and/or applied to traces for certain words, such that the resultant shapewriting model 134 may relatively accurately model sequences of strokes for a variety of different words in a predefined dictionary.

Furthermore, the decoder component 132 may optionally include a language model 136 for a particular language, such as English, Japanese, German, or the like. The language model 136 may be employed to probabilistically disambiguate between potential words based upon previous words set forth by the user.

In some examples, the system 100 includes a display 138 that displays text entered by the user by way of the touch-sensitive input panel 102. In one example, the touch-sensitive input panel 102 is a soft input panel displayed on the display 138 (such that the display is a touch-sensitive display). In another example, the display 138 is a heads-up display in an automobile, a display on a projector, a display on a conventional television or computer screen, or the like. It is to be understood that the touch-sensitive input panel 102, the detector component 130, and/or the decoder component 132 may be included in a separate device from the display 138 (e.g., as an accessory).

The decoder component 132 may employ active learning to update the shapewriting model 134 and/or the language model 136 based upon feedback set forth by the user of the touch-sensitive input panel 102 when setting forth sequences of strokes. That is, the shapewriting model 134 may be refined based upon size of the digit of the user used to set forth the trace over the touch-sensitive input panel 102, shape of traces set forth by the user over the touch-sensitive input panel 102, etc. Similarly, the dictionary utilized by the shapewriting model 134 and/or the language model 136 may be updated based upon words frequently employed by the user of the touch-sensitive input panel 102 and/or an application being executed. For example, if the user desires to set forth a name of a person that is not included in the dictionary of the shapewriting model 134, the user informs the decoder component 132 of the name such that subsequent sequences of strokes corresponding to such name may be recognized and decoded by the decoder component 132. In another example, a dictionary may be customized based upon application; for instance, words/sequences of characters set forth by the user when employing a text messaging application may be different from words/sequences of characters set forth by the user when employing an email or word processing application.

In certain situations, the user of the touch-sensitive input panel 102 may desire to generate text that is not included in a dictionary employed by the shapewriting model 134 and/or the language model 136. In some examples, the decoder component 132 includes a handwriting recognizer component 142 that recognizes handwritten letters set forth by the user over the touch-sensitive input panel 102 or some other proximate touch-sensitive device, such as a portion of a touch-sensitive display that is not displaying the touch-sensitive input panel 102. For example, the user may desire to set forth the sequence of characters “whoooooaaah.” Such sequence of characters may not be included in a dictionary used to decode traces by the shapewriting model 134 and/or the language model 136. To allow the user to set forth such sequence of characters without having to look at the touch sensitive input panel 102 and discretely tap keys, the system 100 may support handwriting recognition, wherein the user may cause the touch-sensitive input panel 102 to enter into a handwriting recognition mode through provision of a voice command, gesture, selection of a button, or the like. Once in the handwriting recognition mode, the user may trace characters on the touch-sensitive input panel 102, and the handwriting recognizer component 142 may recognize the characters being entered by the user. Therefore, the user may first handwrite the letter “w,” and then may set forth a gesture indicating that the character has been completed. The user may thereafter handwrite the letter “o,” which again may be recognized by the handwriting recognizer component 142. This process may continue until the user has set forth the desired sequence of characters. Subsequently, the user, through a voice command, gesture, or the like, may cause the touch-sensitive input panel 102 to transition back to shapewriting mode. Other modes are also possible, such as a mode that supports tapping of keys, if such mode is desired by the user.

The touch-sensitive input panel 102 may be ergonomically arranged to facilitate receipt of strokes from a thumb of the user while the user is holding a mobile computing device, operating a vehicle, or the like. Accordingly, with respect to a mobile computing device, the plurality of keys 104-120 may be angularly offset from a bottom edge, top edge, and side edge of the display screen of the mobile computing device, such that the lines defining boundaries of the keys are not parallel with the edges of the display. Moreover, the keys may be curved, arced, or slanted relative to edges of the display.

To facilitate muscle memory input of a sequence of strokes, different portions of the touch-sensitive input panel 102 may be provided with different textures and/or elevations relative to other portions of the touch-sensitive input panel 102. For instance, keys in the touch-sensitive input panel 102 may be separated by respective boundaries. Such boundaries may be manufactured in a material that is different from the material utilized when manufacturing the keys 104-120. Therefore, the user may receive tactile feedback as to position of a digit on the touch-sensitive input panel 102. In other examples, the touch-sensitive input panel 102 may be configured to output haptic feedback as the digit of the user transitions over boundaries of the touch-sensitive input panel 102. For instance, as a digit of the user crosses a boundary between keys, an electrostatic signal may be output by the touch-sensitive input panel 104. Again, such feedback may allow the user to ascertain that a boundary or boundaries between keys are being transitioned over by the digit. Still further, keys themselves may have different textures: for example, a first key may have a first texture, and a second (adjacent) key may have a second texture (different from the first texture), such that, by feel, the user may differentiate between the first and second key. Therefore, the first key may be smoother than the second key or vice versa.

Elevation of keys may be different in the touch-sensitive input panel 102. For instance, the keys 104-108 may be in a first row having a first elevation relative to a base, the keys 110-114 may be in a second row having a second elevation relative to the base, and the keys 116-120 may be in a third row having a third elevation relative to the base. Thus, by sensing different elevations with her digit, the user may estimate a position of the digit on the touch-sensitive input panel 102. Likewise, columns of keys may have different elevations relative to a base, or each key may have a different elevation.

Boundaries between keys may be configured as bumps or channels, such that the user receives tactile feedback as her digit transitions over the bumps or channels. Therefore, it is to be understood that the touch-sensitive input panel 102 may have various ridges, bumps, etc., to allow the user to tactilely ascertain where her digit is (e.g., upon which key or in which row or columns) as the digit is transitioning over the face of the touch-sensitive input panel 102.

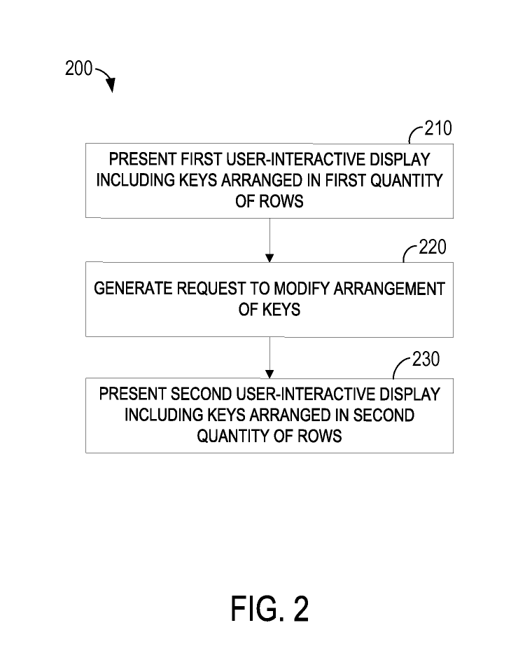

FIG. 2 is a flowchart of an example method 200 of modifying a keyboard in the system 100. A keyboard is presented on the touch-sensitive input panel 102 at 210. The keyboard includes a plurality of keys (e.g., keys 104-120) arranged in a first quantity of rows. The plurality of keys are associated with a first set of characters (e.g., the English alphabet). For example, a first plurality of characters (e.g., “Q,” “W,” and “E”) are associated with a key 104, and a second plurality of characters (e.g., “R,” “T,” and “Y) are associated with a key 106.

A request or instruction to modify an arrangement of the keys is generated at 220. In at least some examples, the request is generated based on a user request received from a user. The request may include one or more parameters that define, enable, or restrict how the keys are to be arranged in the new arrangement. In one example, the request to modify the arrangement is generated to include or be associated with a request to modify a quantity of rows. Based on the generated request, the touch-sensitive input panel 102 presents a modified or a new keyboard at 230. The keyboard includes a plurality of keys (e.g., keys 104-120) arranged in a second quantity of rows different from the first quantity of rows.

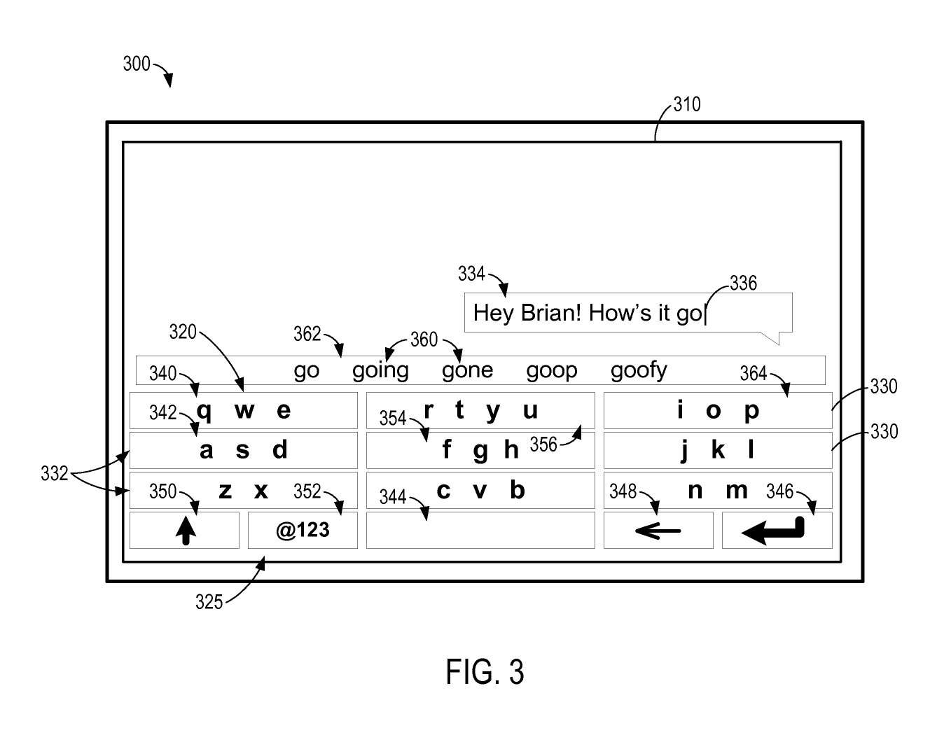

FIG. 3 illustrates a mobile device 300 including a touch-sensitive input panel or touchscreen 310 (e.g., display 138) configured to display or present content (e.g., images, alphanumeric characters). The touchscreen 310 is configured to present a user-interactive display or keyboard 320 (e.g., touch-sensitive input panel 102) including a first arrangement 325 of a plurality of keys 330. The first arrangement 325 includes a first quantity of rows 332. The keys 330 may be arranged in any quantity of rows 332 that enables the touchscreen 310 to function as described herein. As used herein, the term “user-interactive display” is used broadly and includes any virtual keyboard, soft keyboard, or touchscreen keyboard. In one example, the touchscreen 310 is a capacitive touchpad. Alternatively, the touchscreen 310 includes or incorporates any technology that enables the mobile device 300 to function as described herein.

The keys 330 are associated with a first set of characters (e.g., lowercase letters of the English alphabet) and are configured to enable a user to input one or more characters. In some examples, the characters are arranged in accordance with a QWERTY keyboard. In other examples, the characters may be arranged in alphabetical order or some other suitable arrangement.

When a key 330 is selected (e.g., a digit of a user is positioned proximate to the key 330), a corresponding character is input within a text field 334 by positioning the character in a space adjacent to or associated with a cursor 336 and moving the cursor 336 forward one space. In a left-to-right language, such as English, the character is positioned in a space and the cursor 336 is moved to the right once space (e.g., to the right of the most-recently positioned character). In a right-to-left language, such as Arabic, the character is positioned in a space and the cursor 336 is moved to the left once space (e.g., to the left of the most-recently positioned character).

One or more keys 330 are representative of or associated with any quantity of characters that enables the touchscreen 310 to function as described herein. For example, a first key 340 associated with a first plurality of characters (e.g., “q”, “w”, and “e”) enables a user to input a “q”, a “w”, or an “e”. Similarly, a second key 342 associated with a second plurality of characters (e.g., “a”, “s”, and “d”) enables a user to input an “a”, an “s”, or a “d”.

Characters may include alphanumeric characters, characters of another language (e.g., Chinese), symbols, emojis, or spaces. For example, a spacebar 344 is associated with a horizontal whitespace character and enables a user to input a whitespace character, and an enter key 346 is associated with a vertical whitespace character and enables a user to begin a new line. The enter key 346 may also be configured to initiate a predetermined action (e.g., enter or submit the inputted characters).

One or more keys 330 are configured not to input one or more characters into the text field 334. For example, a backspace key 348 is configured to delete a character adjacent to the cursor 336 and move the cursor 336 backward one space. In a left-to-right language, the character in a space to the left of the cursor 336 is deleted and the cursor 336 is moved to the left once space. In a right-to-left language, the character in a space to the right of the cursor 336 is deleted and the cursor 336 is moved to the right once space. For another example, a shift key 350 is configured to change or modify one or more characters associated with one or more other keys 330 such that, when the shift key 350 is selected, one or more other keys 330 are associated with an alternate version of the first set of characters (e.g., uppercase letter of the English alphabet). For yet another example, a character set shift key 352 is configured to change or modify one or more characters associated with one or more other keys 330 such that, when the character set shift key 352 is selected, one or more other keys 330 are associated with a different set of characters (e.g., a second set of characters). In at least some examples, the character set shift key 352 is configured to change or modify a dictionary of terms associated with the keyboard 320.

In some examples, the touchscreen 310 is configured to receive input from a user by way of shapewriting (e.g., a continuous sequence of strokes over the touchscreen 310). As used herein, the term “shapewriting” is a continuous interaction with a touch-sensitive input panel to select one or more keys 330, rather than the tapping of discrete keys 330. As used herein, a “stroke” is the continuous interaction with a touch-sensitive input panel between one key 330 and another key 330. In other words, rather than the user individually tapping keys 330 on the touchscreen 310, the user may employ a digit, a stylus, or other input device to connect keys 330 that are representative of respective letters in a desired word.

In an example, a user may desirably employ the touchscreen 310 to enter the word “hey.” The user may initially place her digit on an “fgh” key 354 associated with the characters “f”, “g” and “h” and transition her digit front the “fgh” key 354 to the “qwe” key 340 associated with the characters “q”, “w”, and “e”. The transition between the “fgh” key 354 and the “qwe” key 340 is a first stroke. While maintaining contact with the touchscreen 310, the user may continuously interact with the touchscreen 310 between the “qwe” key 340 and a “rtyu” key 356 associated with the characters “r”, “t”, “y”, and “u.” Accordingly, by transitioning between the “qwe” key 340 and the “rtyu” key 356, the user has set forth a second stroke. Thus, the user has selected keys 330 representative of the letters of the word “hey.” When the user has completed a word, the user may stop or interrupt interaction with the touchscreen 310 by lifting her digit from the “nyu” key 356.

In at least some examples, the user may desire to indicate a selection of a letter that is associated with a key 330 that was used to select the most recent letter. A relatively small stroke (e.g., a circular pattern) made over the key 330 may be interpreted as another selection of the key 330. Additionally or alternatively, a pause over the key 330 may be interpreted as another selection of the key 330. While the sequence of strokes are described as being discrete strokes, it is to be understood that, in practice, a continuous sequence of strokes may appear as a continuous, curved shape with no readily ascertainable differentiation between strokes.

The mobile device 300 is configured to disambiguate between potential words based upon characters associated with one or more selected keys 330 and the sequence of the selected keys 330. The mobile device 300 may compare various combinations of characters with a dictionary of terms to probabilistically disambiguate between potential words based upon one or more words in the dictionary of terms. For example, the mobile device 300 may interpret the sequence of keys 354, 340, 356 as “get”, “her”, or “hey” and not as “fqr” (among other combinations of characters). In some combinations, the mobile device 300 is configured to automatically capitalize a first letter in a sentence (e.g., “Hey”, “How's”) and/or a first letter in a proper noun (e.g., “Brian”). Additionally or alternatively, the mobile device 300 may be configured to correct for possible spelling errors based upon one or more words in the dictionary of terms and/or previous words set forth by the user.

The mobile device 300 may employ active learning to update the dictionary of terms based upon feedback set forth by the user of the touchscreen 310 when setting forth sequences of strokes. For example, the dictionary of terms may be updated based upon words previously employed by the user of the touchscreen 310 and/or an application being executed.

The mobile device 300 is configured to anticipate or generate one or more suggestions 360 based on characters associated with one or more selected keys 330, the sequence of the selected keys 330, one or more other words in the text field 334, and/or one or more words in the dictionary of terms and present the suggestions 360 in a prediction field 362. In an example, a user may desirably employ the touchscreen 310 to enter the word “going.” The user may initially place her digit on a “fgh” key 354 associated with the characters “f”, “g”, and “h” and transition her digit from the “fgh” key 354 to a “iop” key 364 associated with the characters “i”, “o”, and “p”. In this example, the mobile device 300 may interpret the sequence of keys 354, 364 as “go” or predict one or more suggestions 360 including “going”, “gone”, “goop”, and “goofy”, and the user may select one of the suggestions 360 for input. The mobile device 300 may iteratively predict one or more suggestions 360 as the characters are input (or deleted) from the text field 334.

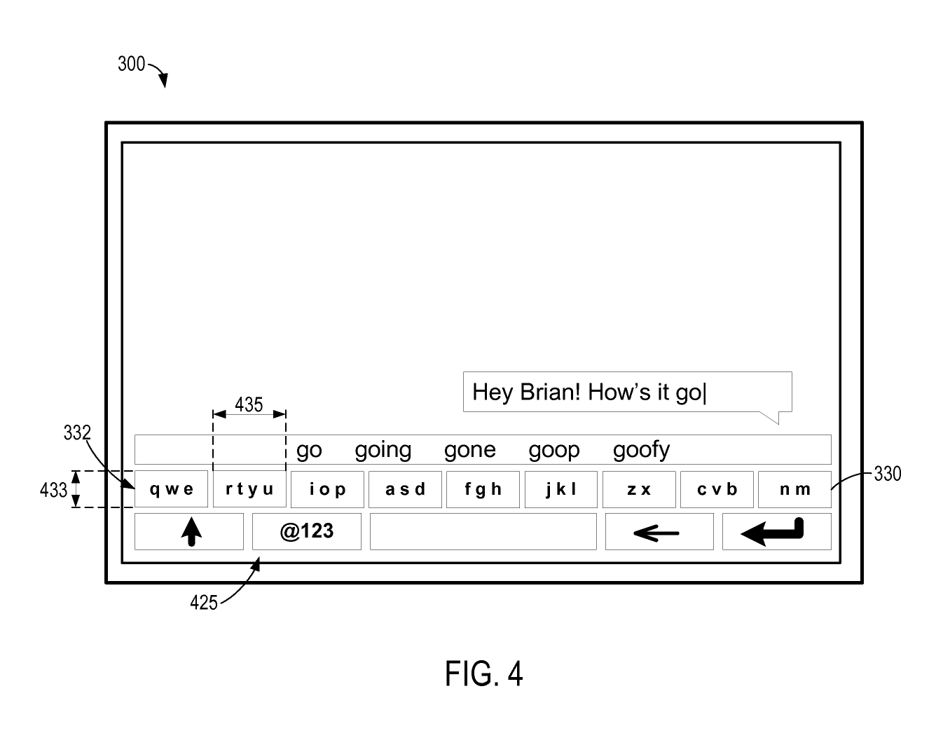

In some examples, the mobile device 300 is configured to determine and/or modify the first arrangement 325 of keys 330. The first arrangement 325 may be modified to include more, fewer, or the same quantity of rows 332; more, fewer, or the same quantity of keys 330 within one or more rows 332, and/or more, fewer, or the same quantity of characters associated with one or more keys 330. For example, FIG. 4 illustrates a second arrangement 425 of the plurality of keys 330 on the mobile device 300. The second arrangement 425 includes fewer rows 332, the same quantity of keys 330, and the same quantity of characters associated with the keys 330. A user may prefer the first arrangement 325, for example, because the keys 330 are larger in size. Alternatively, the user may prefer the second arrangement 425, for example, because a larger portion of the touchscreen 310 is not occupied by the keyboard 320. The mobile device 300 enables the user to customize the keyboard 320 based on one or more parameters.

A request or instruction to modify an arrangement of keys 330 may be generated based on one or more parameters. An arrangement may include any combination of keys 330 and/or characters that enable the keyboard 320 to function as described herein. The keys 330 may be arranged based on one or more layout parameters associated with the keyboard 320. Layout parameters include, without limitation, a quantity of rows 332, a quantity of keys 330, a row or key height 433 (shown in FIG. 4), a key width 435 (shown in FIG. 4), a quantity of characters, a portion of the touchscreen 310 occupied by the keyboard 320, an orientation of the touchscreen 310 (e.g., portrait orientation, landscape orientation), a quantity of hands, and/or a hand or handedness. Alternatively, the layout parameters may include any combination of parameters that enables the keyboard 320 to function as described herein. In some examples, a predetermined combination of layout parameters (e.g., default user settings) provide an out-of-box experience. In at least some examples, one or more layout parameters may be added, removed, and/or modified (e.g., through a switching mechanism) to provide a customized user experience. That is, the user settings may be expressly modified by a user to provide the customized user experience.

One or more layout parameters may be fixed when an arrangement of keys 330 is modified (e.g., when one or more layout parameters are being modified). For example, to modify a keyboard 320 between the first arrangement 325 and the second arrangement 425, the quantity of rows 332, the key width 435 of one or more keys 330, and the portion occupied by the keyboard 320 are modified while the quantity of keys 330 and the key height 433 are fixed.

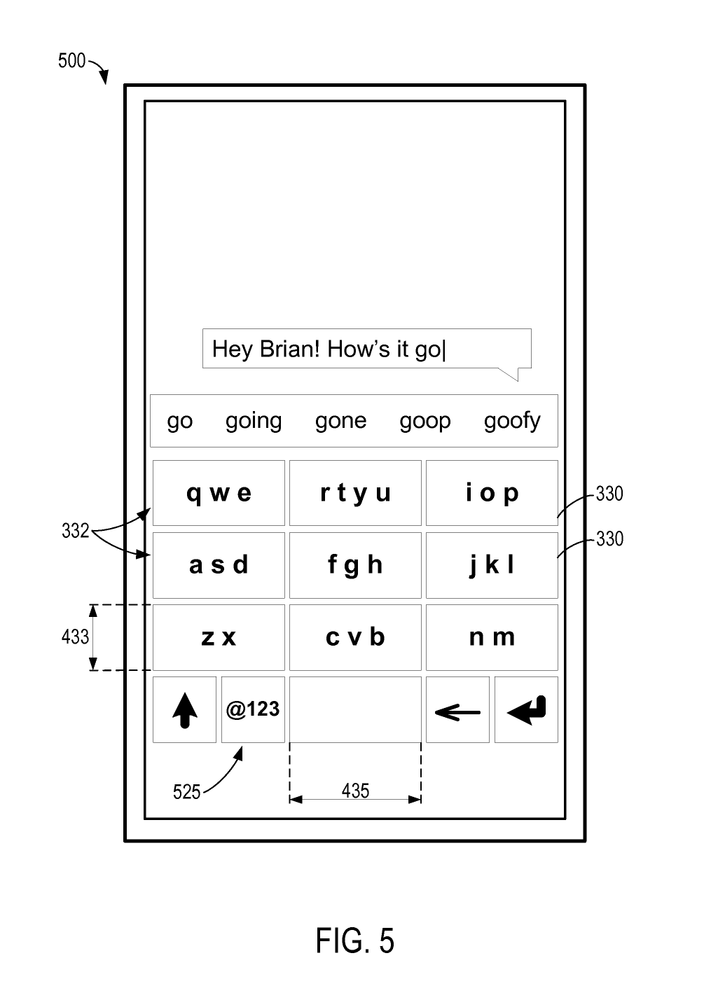

In some examples, the arrangement is modified based on an orientation of the keyboard 320 and/or one or more device parameters (e.g., size of the touchscreen 310). FIG. 5 illustrates a third arrangement 525 of the plurality of keys 330 on another mobile device 300 in the portrait orientation. To modify a keyboard 320 between the first arrangement 325 and the third arrangement 525, the size (e.g., key height 433, key width 435) of one or more keys 330 is modified while the quantity of rows 332 and the quantity of keys 330 are fixed.

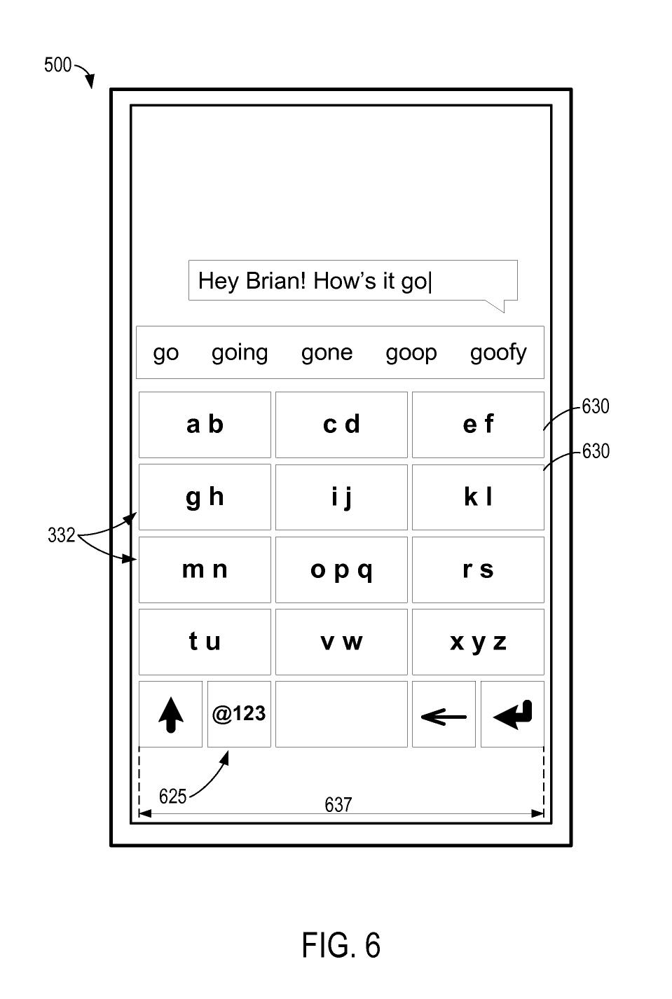

The arrangement may also be modified based on one or more characters associated with one or more keys 330. FIG. 6 illustrates a fourth arrangement 625 of a plurality of keys 630 different from the plurality of keys 330 on the mobile device 500. To accommodate the desired quantity of characters associated with one or more keys, the fourth arrangement 625 includes a greater quantity of keys 630 than the third arrangement 525. To modify a keyboard 320 between the third arrangement 525 and the fourth arrangement 625, the characters associated with one or more keys 330 or 630 and the quantity of rows 332 are modified while the key size is fixed.

In at least some examples, the arrangement is modified based on a desired hand or a desired quantity of hands. When both hands are desired (or neither hand is desired over the other), the keys 330 may extend over substantially a width 637 of the touchscreen 310. In one example, the keys 330 are arranged in a “split” keyboard configuration, wherein the keys 330 are arranged in a first set on a left-hand side of the touchscreen 310, and a second set on a right-hand side of the touchscreen 310.

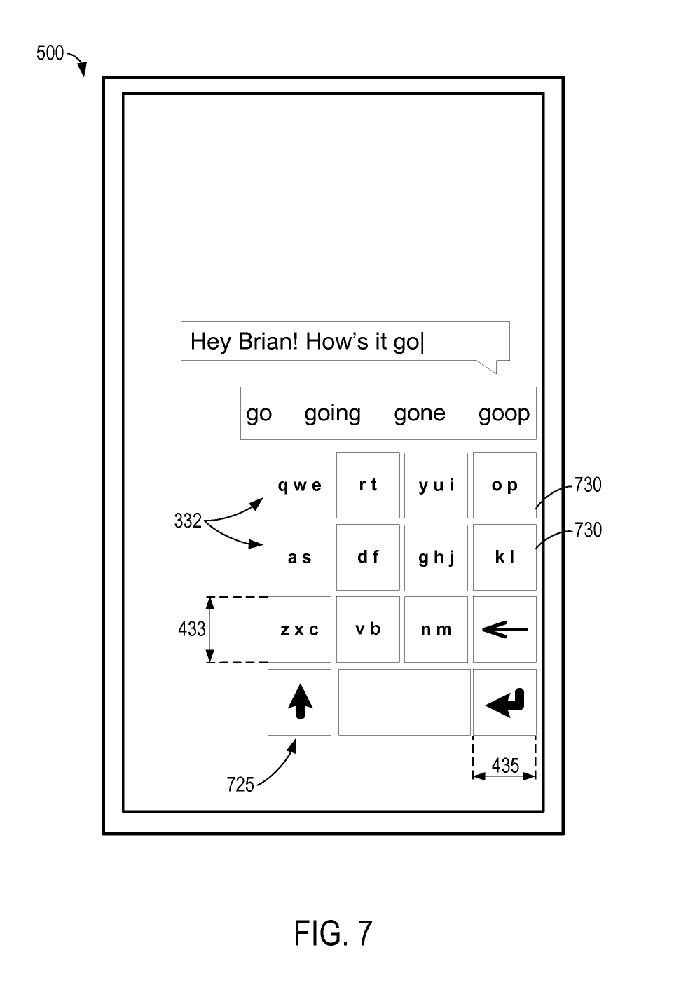

When one hand is desired or preferred over the other hand, the keys 330 may be biased toward the desired hand. FIG. 7 illustrates a fifth arrangement 725 of another plurality of keys 730 different from the plurality of keys 330 or 630 on the mobile device 500. The keys 730 are translated towards the right-hand side for a right-handed user. Alternatively, the keys 730 may be translated towards the left-hand side for a left-handed user. To accommodate the narrower width of the keyboard 320, the fifth arrangement 725 includes a fewer quantity of keys 730 than the third arrangement 525. In this example, one or more keys 730 are associated with fewer characters than the keys 330. To modify a keyboard 320 between the third arrangement 525 and the fifth arrangement 725, the characters associated with one or more keys 330 or 730, the quantity of keys 330 or 730, and the key width 435 are modified while the quantity of rows 332 and the key height 433 are fixed.

In some examples, one or more layout parameters are determined based on one or more user parameters. That is, in at least some examples, one or more user settings (e.g., layout parameters) may be based on one or more other user settings (e.g., user parameters). User parameters include, without limitation, a typing mode (e.g., tap typing mode, shapewriting mode), typing words per minute, a user accuracy rate (e.g., a percentage of corrected words), and/or a user-intelligence accuracy rate (e.g., a percentage of suggestions 360 selected by the user). For example, a keyboard 320 may be associated with a smaller key size and/or a fewer quantity of rows 332 for users that have a higher user accuracy rate. Alternatively, the user parameters may include any combination of parameters that enables the keyboard 320 to function as described herein. Additionally or alternatively, one or more layout parameters may be determined based on one or more application parameters. Application parameters include, without limitation, a functionality of an application and/or a layout of the application. For example, one or more application parameters may add, remove, and/or modify one or layout parameters such that a keyboard associated with or customized to the application is presented.

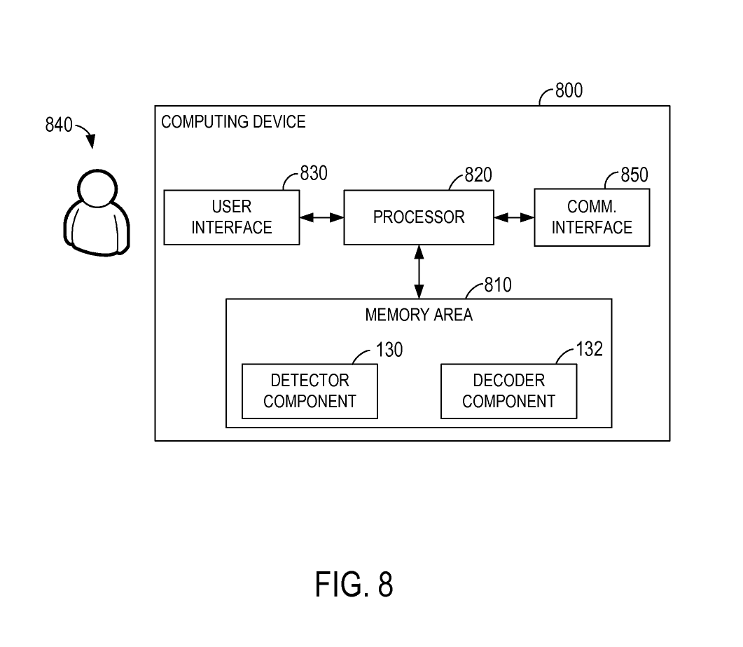

FIG. 8 is a schematic diagram of an example computing device 800 that may be used with a mobile device (e.g., mobile device 300 or a mobile device 500). While some examples of the disclosure are illustrated and described herein with reference to the computing device 800 being or including a mobile telephone, a phablet, or a tablet, aspects of the disclosure are operable with any computing device that executes instructions to implement the operations and functionality associated with the computing device 800. For example, the computing device 800 may include a portable media player, a netbook, a laptop, a desktop computer, a computing pad, a kiosk, a tabletop device, an industrial control device, a wireless charging station, an electric automobile charging station, and other computing devices. Additionally, the computing device 800 may represent a group of processing units or other computing devices. Additionally, any computing device described herein may be configured to perform any operation described herein including one or more operations described herein as being performed by another computing device.

The computing device 800 includes one or more computer-readable media, such as a memory area 810 storing computer-executable instructions, a detector component 130, a decoder component 132, user settings, and other data, and one or more processors 820 programmed to execute the computer-executable instructions for implementing aspects of the disclosure. The memory area 810 includes any quantity of media associated with or accessible by the computing device 800. The memory area 810 may be internal to the computing device 800 (as shown in FIG. 8), external to the computing device 800 (not shown), or both (not shown).

The processor 820 includes any quantity of processing units, and the instructions may be performed by the processor 820 or by multiple processors within the computing device 800 or performed by a processor external to the computing device 800. The processor 820 is programmed to execute instructions such as those illustrated in the figures (e.g., FIGS. 2 and/or 9).

In some examples, the processor 820 is transformed into a special purpose microprocessor by executing computer-executable instructions or by otherwise being programmed. For example, the detector component 130, when executed by the processor 820, causes the processor 820 to detect a sequence of strokes over a touchscreen 310; and the decoder component 132, when executed by the processor 820, causes the processor 820 to decode a word based at least in part upon a sequence of strokes. Although the processor 820 is shown separate from the memory area 810, examples of the disclosure contemplate that the memory area 810 may be onboard the processor 820 such as in some embedded systems.

The computing device 800 includes at least one user interface 830 for exchanging data between the computing device 800 and a user 840. For example, the user interface 830 includes or is coupled to a presentation device configured to present information, such as text, images, audio, video, graphics, alerts, and the like, to the user 840. The presentation device may include, without limitation, a display, a speaker, or a vibrating component. Additionally or alternatively, the user interface 830 includes or is coupled to an input device (not shown) configured to receive information, such as user commands, from the user 840. The input device may include, without limitation, a controller, a camera, a microphone, or an accelerometer. In at least some examples, the presentation device and the input device are integrated in a common user interface 830 configured to present information to the user 840 and receive information from the user 840. For example, the user-interface device may include, without limitation, a capacitive touch screen display (e.g., (e.g., touchscreen 310) or a controller including a vibrating component.

The computing device 800 includes at least one communication interface 850 for exchanging data between the computing device 800 and a computer-readable media or another computing device. For example, the mobile device 300 may be coupled to a server via a network. Communication between the computing device 800 and a computer-readable media or another computing device may occur using any protocol or mechanism over any wired or wireless connection.

The block diagram of FIG. 8 is merely illustrative of an example system that may be used in connection with one or more examples of the disclosure and is not intended to be limiting in any way. Further, peripherals or components of the computing devices known in the art are not shown, but are operable with aspects of the disclosure. At least a portion of the functionality of the various elements in FIG. 8 may be performed by other elements in FIG. 8, or an entity (e.g., processor, web service, server, applications, computing device, etc.) not shown in FIG. 8.

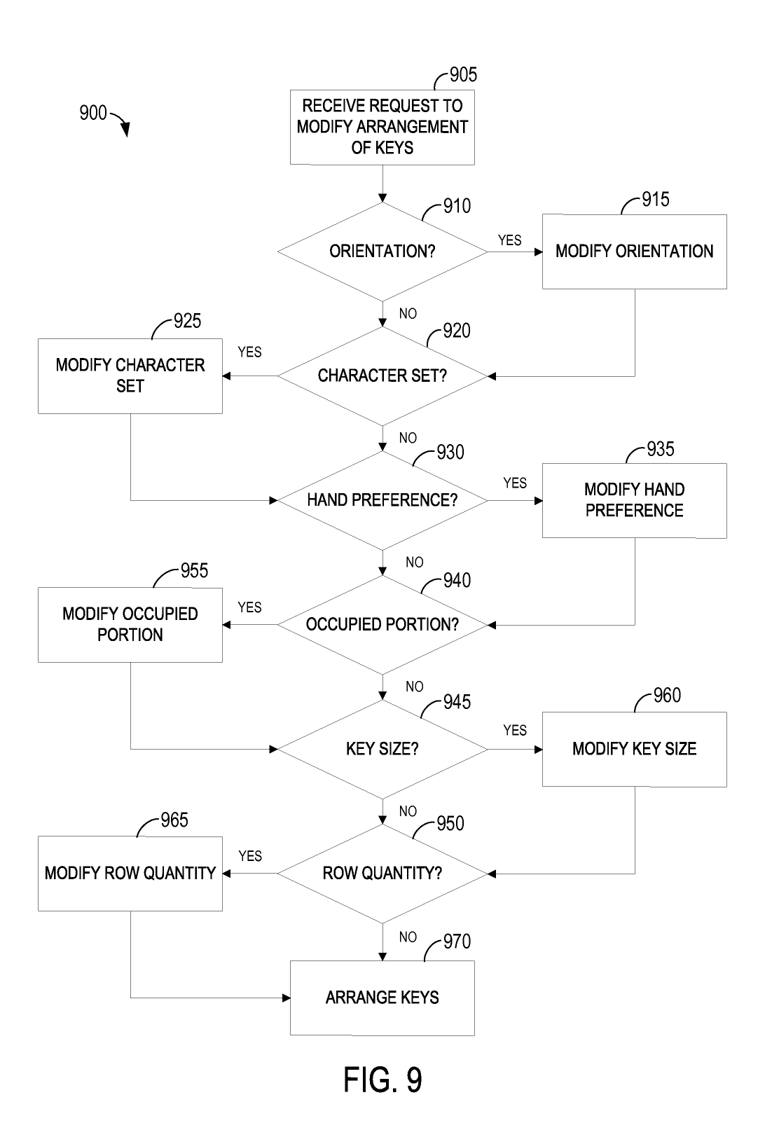

FIG. 9 is a flowchart of an example method 900 of modifying a keyboard 320 using the computing device 800 (e.g., mobile device 300, mobile device 500). A keyboard 320 includes a plurality of keys 330 arranged in a first quantity of rows 332. The keys 330 are associated with a first set of characters (e.g., lowercase letters of the English alphabet). For example, a first key 340 is associated with a first plurality of characters, and a second key 342 is associated with a second plurality of characters.

A request to modify an arrangement of the keys 330 is received at 905. In some examples, the request includes or is associated with a desired modification of a quantity of rows 332, a size associated with one or more keys 330, a portion of the touchscreen 310, a hand, a quantity of hands, a typing style, a set of characters, and/or an orientation of the touchscreen 310 and/or the keyboard 320. The request may be associated with one or more parameters including, without limitation, a quantity of rows 332, a key size, an occupied portion of the touchscreen 310, a hand, a quantity of hands; a typing style, an accuracy rate, an orientation, and/or a set of characters. For example, the computing device 800 may determine at 910 whether the request is associated with an orientation of the touchscreen 310 and/or the keyboard 320. Upon determining that the orientation is to be modified, the computing device 800 modifies the orientation at 915. FIG. 3 illustrates a keyboard 320 in a landscape orientation, and FIG. 4 illustrates a keyboard 320 in a portrait configuration.

The computing device 800 may determine at 920 whether the request is associated with a character set. Upon determining that the character set is to be modified, the computing device 800 modifies the character set at 925. In at least some examples, the character set may be modified by selecting the shift key 350 and/or the character set shift key 352. In some examples, the keyboard 320 is associated with a second set of characters such that the first key 340 is associated with a third plurality of characters and the second key 342 is associated with a fourth plurality of characters.

The computing device 800 may determine at 930 whether the request is associated with a hand preference (e.g., a desired quantity of hands, a desired hand). Upon determining that the hand preference is to be modified, the computing device 800 modifies the hand preference at 935. For example, the hand preference may identify whether use of a left hand, a right hand, both hands, or neither hand is preferred. Upon identifying that one hand (e.g., left hand, right hand) is preferred, the computing device 800 enables the keyboard 320 to be translated to one side (e.g., the left-hand side, the right-hand side). FIG. 7 illustrates the keyboard 320 translated to the right-hand side of the touchscreen 310. Upon identifying that both hands or no hands are preferred, the computing device 800 enables the keyboard 320 to be partitioned into a first set on a left-hand side of the touchscreen 310 and a second set on a right-hand side of the touchscreen 310 (e.g., a split keyboard configuration).

The computing device 800 may determine at 940, 945, and/or 950 whether the request is associated with a portion of the touchscreen 310 occupied by the keyboard 320, a key size, and/or a row quantity, respectively. Upon determining that the keyboard 320 (e.g., the occupied portion, the key size, the row quantity) is to be modified, the computing device 800 modifies the occupied portion, the key size, and/or the row quantity at 955, 960, and 965, respectively. Based on one or more parameters (e.g., a row quantity, a key size, an occupied portion, a hand, a quantity of hands, a character set, an orientation, a typing style), the keys 330 are arranged in a second quantity of rows 332 different from the first quantity of rows 332 at 920. The arrangement may be determined based on one or more parameters.

In some examples, one or more parameters are determined based on an express request by the user 840 (e.g., the request includes a desired portion of the touchscreen 310, a desired key size, a desired row quantity, and/or a desired quantity of characters associated with one or more keys 330). Additionally or alternatively, one or more parameters are determined based on one or more device features (e.g., a size of the computing device 800, a size of the touchscreen 310). Additionally or alternatively, one or more parameters are determined based on a learning module that tracks one or more user interactions over time. For example, the learning module may identify or determine an accuracy rate associated with a user 840 and/or suggestions 360 presented to the user 840. In this manner, a keyboard 320 may be modified to accommodate various typing styles, finger sizes, and/or dexterities.

The subject matter described herein enables a mobile device to modify an arrangement of a plurality of keys on a user-interactive display. In this way, the user-interactive display may be configured to accommodate one or more user preferences or parameters (e.g., a key size, a quantity of rows, a quantity of characters associated with a key, a portion of the touch-sensitive input panel occupied by the user-interactive display, a handedness, a quantity of hands handling the mobile device, a typing style).

Example computer-readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this disclosure are not signals per se. Example computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an example computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

The examples illustrated and described herein as well as examples not specifically described herein but within the scope of aspects of the disclosure constitute example means for modifying a user-interactive display. For example, the elements illustrated in FIG. 8, such as when encoded to perform the operations illustrated in FIG. 9 constitute at least an example means for generating a request to modify an arrangement of a plurality of keys presented on a touch-sensitive input panel, an example means for arranging a plurality of keys, an example means for detecting a sequence of strokes over a touch-sensitive input panel, and/or an example means for decoding a word based at least in part upon a sequence of strokes.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The phrase “one or more of the following: A. B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

Alternatively or in addition to the other examples described herein, examples include any combination of the following:

generating a request to modify an arrangement of a plurality of keys presented on the touch-sensitive input panel;

the plurality of keys arranged in a first quantity of rows and associated with a first set of characters including a first plurality of characters and a second plurality of characters;

a first key of the plurality of keys associated with the first plurality of characters and a second key of the plurality of keys associated with the second plurality of characters;

generating a request associated with a quantity of rows;

generating a request associated with a size of at least one of the plurality of keys;

generating a request associated with a portion of the touch-sensitive input panel;

generating a request associated with a hand;

generating a request associated with a quantity of hands;

generating a request associated with a typing style;

identifying an accuracy rate associated with the plurality of keys;

identifying an orientation of the touch-sensitive input panel;

generating a request associated with a second set of characters including a third plurality of characters and a fourth plurality of characters;

associating the first key with the third plurality of characters;

associating the second key with the fourth plurality of characters;

determining the second quantity of rows;

a touch-sensitive input panel configured to present a user-interactive display including a plurality of keys:

a memory storing computer-executable instructions;

a processor configured to present a first user-interactive display including a plurality of keys arranged in a first quantity of rows;

a processor configured to generate a request to modify an arrangement of the plurality of keys;

a processor configured to generate a request associated with one or more of a quantity of rows, a size of at least one of the plurality of keys, and a portion of the touch-sensitive input panel:

a processor configured to generate a request associated with one or more of a hand and a quantity of hands;

a processor configured to generate a request associated with a typing style;

a processor configured to generate a request associated with the plurality of keys being arranged in the first quantity of rows;

a processor configured to identify an orientation of the touch-sensitive input panel:

a processor configured to identify an orientation of the touch-sensitive input panel;

a processor configured to determine the second quantity of rows:

a processor configured to present a second user-interactive display including the plurality of keys arranged in a second quantity of rows different from the first quantity of rows;

a detector component configured to detect a sequence of strokes over the touch-sensitive input panel, wherein a stroke is a continuous transition of a human digit over the touch-sensitive input panel between respective keys of the plurality of keys, and wherein the human digit maintains contact with the touch-sensitive input panel during the sequence of strokes;

a detector component configured to generate a request to modify an arrangement of the plurality of keys and, based on the generated request, the touch-sensitive input panel is configured to modify the arrangement of the plurality of keys;

a detector component configured to identify an orientation of the touch-sensitive input panel and, based on the identified orientation of the touch-sensitive input panel, the touch-sensitive input panel is configured to modify an arrangement of the plurality of keys;

a decoder component configured to decode a word based at least in part upon the sequence of strokes detected by the detector component; and

a decoder component is configured to identify an accuracy rate associated with the decoded word and, based on the identified accuracy rate, the touch-sensitive input panel is configured to modify an arrangement of the plurality of keys.

In some examples, the operations illustrated in the drawings may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

What is claimed is:

1. A computer-implemented method for modifying a user-interactive display presented on a touch-sensitive input panel, the computer-implemented method comprising:
generating a request to modify an arrangement of a plurality of keys presented on the touch-sensitive input panel, the plurality of keys arranged in a first quantity of rows and associated with a first set of characters including a first plurality of characters and a second plurality of characters, a first key of the plurality of keys associated with the first plurality of characters and a second key of the plurality of keys associated with the second plurality of characters; and
based on the generated request, arranging the plurality of keys in a second quantity of rows different from the first quantity of rows.

2. The computer-implemented method of claim 1, wherein generating a request comprises:
generating the request, wherein the request is associated with a quantity of rows; and
based on the quantity of rows, determining the second quantity of rows.

3. The computer-implemented method of claim 1, wherein generating a request comprises:
generating the request, wherein the request is associated with a size of at least one of the plurality of keys; and
based on the size of the at least one of the plurality of keys, determining the second quantity of rows.

4. The computer-implemented method of claim 1, wherein generating a request comprises:
generating the request, wherein the request is associated with a portion of the touch-sensitive input panel; and
based on the portion of the touch-sensitive input panel, determining the second quantity of rows, the plurality of keys occupying the portion of the touch-sensitive input panel.

5. The computer-implemented method of claim 1, wherein generating a request comprises:
generating the request, wherein the request is associated with a hand; and
based on the hand, determining the second quantity of rows.

6. The computer-implemented method of claim 1, wherein generating a request comprises:
generating the request, wherein the request is associated with a quantity of hands; and
based on the quantity of hands, determining the second quantity of rows.

7. The computer-implemented method of claim 1, wherein generating a request comprises:
generating the request, wherein the request is associated with a typing style, and
based on the typing style, determining the second quantity of rows.

8. The computer-implemented method of claim 1, wherein generating a request comprises:
identifying an accuracy rate associated with the plurality of keys being arranged in the first quantity of rows; and
based on the identified accuracy rate, determining the second quantity of rows.

9. The computer-implemented method of claim 1, wherein generating a request comprises:
identifying an orientation of the touch-sensitive input panel; and
based on the identified orientation of the touch-sensitive input panel, determining the second quantity of rows.

10. The computer-implemented method of claim 1, wherein generating a request comprises:
generating the request, wherein the request is associated with a second set of characters including a third plurality of characters and a fourth plurality of characters;
associating the first key with the third plurality of characters;
associating the second key with the fourth plurality of characters; and
based on the second set of characters, determining the second quantity of rows.

11. A mobile device for modifying a user-interactive display, the mobile device comprising:
a touch-sensitive input panel configured to present the user-interactive display;
a memory storing computer-executable instructions; and
a processor configured to execute the computer-executable instructions to:
present, on the touch-sensitive input panel, a first user-interactive display including a plurality of keys arranged in a first quantity of rows, a first key of the plurality of keys representative of a first plurality of characters and a second key of the plurality of keys representative of a second plurality of characters;
generate a request to modify an arrangement of the plurality of keys; and
present, on the touch-sensitive input panel, a second user-interactive display including the plurality of keys arranged in a second quantity of rows different from the first quantity of rows.

12. The mobile device of claim 11, wherein the processor is further configured to execute the computer-executable instructions to:
generate the request, wherein the request is associated with one or more of a quantity of rows, a size of at least one of the plurality of keys, and a portion of the touch-sensitive input panel; and
based on the one or more of the quantity of rows, the size of at least one of the plurality of keys, and the portion of the touch-sensitive input panel, determine the second quantity of rows.

13. The mobile device of claim 11, wherein the processor is further configured to execute the computer-executable instructions to:
generate the request, wherein the request is associated with one or more of a hand and a quantity of hands; and
based on the one or more of the hand and the quantity of hands, determine the second quantity of rows.

14. The mobile device of claim 11, wherein the processor is further configured to execute the computer-executable instructions to:
generate the request, wherein the request is associated with a typing style; and
based on the typing style, determine the second quantity of rows.

15. The mobile device of claim 11, wherein the processor is further configured to execute the computer-executable instructions to:
identify an accuracy rate associated with the plurality of keys being arranged in the first quantity of rows; and
based on the identified accuracy rate, determine the second quantity of rows.

16. The mobile device of claim 11, wherein the processor is further configured to execute the computer-executable instructions to:
identify an orientation of the touch-sensitive input panel; and
based on the identified orientation of the touch-sensitive input panel, determine the second quantity of rows.

17. A computing device comprising:
a touch-sensitive input panel configured to present a user-interactive display including a plurality of keys, the plurality of keys configurable between a first arrangement including a first quantity of rows and a second arrangement including a second quantity of rows different from the first quantity of rows;
a detector component configured to detect a sequence of strokes over the touch-sensitive input panel, wherein a stroke is a continuous transition of a human digit over the touch-sensitive input panel between respective keys of the plurality of keys, and wherein the human digit maintains contact with the touch-sensitive input panel during the sequence of strokes; and
a decoder component configured to decode a word based at least in part upon the sequence of strokes detected by the detector component.

18. The computing device of claim 17, wherein the detector component is configured to generate a request to modify an arrangement of the plurality of keys and, based on the generated request, the touch-sensitive input panel is configured to modify the arrangement of the plurality of keys.

19. The computing device of claim 17, wherein the decoder component is configured to identify an accuracy rate associated with the decoded word and, based on the identified accuracy rate, the touch-sensitive input panel is configured to modify an arrangement of the plurality of keys.

20. The computing device of claim 17, wherein the detector component is configured to identify an orientation of the touch-sensitive input panel and, based on the identified orientation of the touch-sensitive input panel, the touch-sensitive input panel is configured to modify an arrangement of the plurality of keys.
